(19) United States
(12) Patent Application Publication
(10) Pub. No.: US 2021/0352588 A1
(43) Pub. Date: Nov. 11, 2021

(54) METHOD FOR UE POWER SAVING

(71) Applicant: ZTE Corporation, Shenzhen (CN)

(72) Inventors: Jing LIU, Shenzhen (CN); He HUANG, Shenzhen (CN); Xiaojuan SHI, Shenzhen (CN)

(73) Assignee: ZTE Corporation, Shenzhen (CN)

(21) Appl. No.: 17/382,643

(22) Filed: Jul. 22, 2021

Related U.S. Application Data
(63) Continuation of application No. PCT/CN2019/074651, filed on Feb. 2, 2019.

(51) Int. Cl. H04W 52/02; H04W 24/10

(52) U.S. Cl. CPC H04W 52/0235; H04W 52/0232; H04W 24/10

(57) ABSTRACT

Methods, systems, and devices related to related to digital wireless communication, and more specifically, to techniques related to improve terminal power consumption. In one exemplary aspect, a method for wireless communication includes receiving a power configuration from a network node. The method also includes modifying a power configuration based on the power configuration instruction. In another exemplary aspect, a method for wireless communication includes transmitting a power configuration instruction based on terminal assistance information to a terminal, wherein the terminal is configured to modify a power configuration based on the power configuration instruction. The method also includes receiving updated terminal assistance information from the terminal.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, are being discussed.

### SUMMARY

This document discloses methods, systems, and devices related to digital wireless communication, and more specifically, to techniques related to improving terminal power consumption.

In one exemplary aspect, a method for wireless communication is disclosed. The method includes receiving a power configuration instruction based on terminal assistance information from a network node. The method also includes modifying a power configuration based on the power configuration instruction.

In another exemplary aspect, a method for wireless communication includes transmitting a power configuration instruction based on terminal assistance information to a terminal, wherein the terminal is configured to modify a power configuration based on the power configuration instruction. The method also includes receiving updated terminal assistance information from the terminal.

In another exemplary aspect, a wireless communications apparatus comprising a processor is disclosed. The processor is configured to implement a method described herein.

In yet another exemplary aspect, the various techniques described herein may be embodied as processor-executable code and stored on a computer-readable program medium.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1 shows an exemplary schematic diagram of a system architecture for Dual Connectivity (DC).

FIG. 2 illustrates a signaling process to manage UE power consumption.

FIG. 3 illustrates an example bitmap for a transmitted beam in a serving cell.

FIG. 4 illustrates a bitmap representing beams to be measured.

FIG. 5 illustrates a serving cell and a neighbor cell.

FIG. 6 is an illustration of a bitmap for a measured cell list.

FIG. 7 illustrates a block diagram of a method for improving terminal power consumption.

FIG. 8 shows an example of a wireless communication system where techniques in accordance with one or more embodiments of the present technology can be applied.

FIG. 9 is a block diagram representation of a portion of a hardware platform.

### DETAILED DESCRIPTION

The development of the new generation of wireless communication—5G New Radio (NR) communication—is a part of a continuous mobile broadband evolution process to meet the requirements of increasing network demand. NR will provide greater throughput to allow more users connected at the same time. Other aspects, such as energy consumption, device cost, spectral efficiency, and latency are also important to meeting the needs of various communication scenarios.

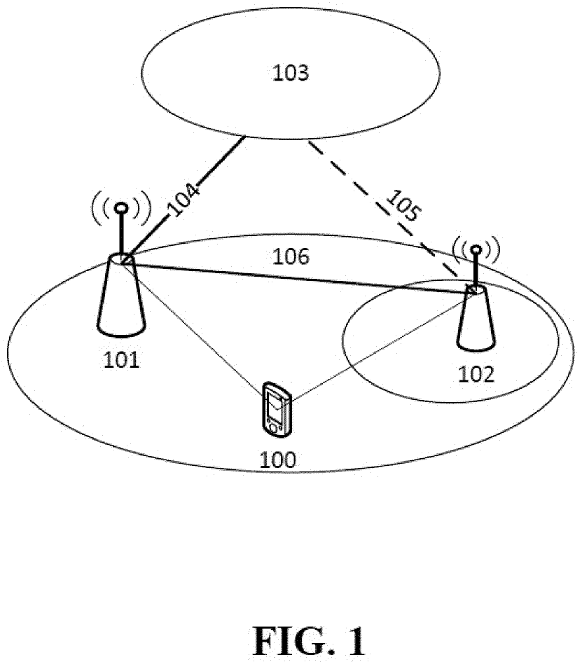

As NR emerges in the wireless domain, UEs will be capable of supporting both protocols at the same time. FIG.1 shows an exemplary schematic diagram of a system architecture for Dual Connectivity (DC). The current base station (referred to as the first network element 81) in the core network 103 may select a suitable base station for the UE 80 to function as the second network element 82. For example, the suitable based station can be selected by comparing the channel quality of the base station with a predetermined threshold. Both base stations can provide radio resources to the UE 80 for data transmission on the user plane. On the wired interface side, the first network element 81 and the core network 103 establish a control plane interface 104 for the UE 80. The second network element 82 and the core network 103 may establish a user plane interface 105 for the UE 80. An interface 106 (e.g., Xn interface) inter-connects the two network elements. On the wireless interface side, the first and the second network elements (81 and 82) may provide radio resources using the same or different Radio Access Technologies (RATs). Each of the network element can schedule transmissions with the UE 80 independently. The network element that has a control plane connection to the core network is referred to as the master node (e.g., the first network element 81), and the network element that has only a user plane connection with the core network is referred to as the secondary node (e.g., the second network element 82). In some cases, the UE 80 can be connected to more than two nodes, with one node acting as the primary note and the remaining acting as the secondary nodes.

In some embodiments, a UE can support a LTE-NR dual connection (DC). For example, one of the typical LTE-NR dual connectivity architectures can be set up as follows: the master node is an LTE RAN node (e.g., eNB) and the secondary node is an NR RAN node (e.g., gNB). The eNB and the gNB are simultaneously connected the Evolved Packet Core (EPC) network (e.g., LTE core network). The architecture shown in FIG. 1 can also be modified to include various master/secondary node configurations. For example, a NR RAN node can be the master node and the LTE RAN node can be the secondary node. In such case, the core network for the master NR RAN node is a Next Generation Converged Network (NG-CN).

UE capabilities for the LTE protocol and the NR protocol in LTE-NR DC include two parts: common capabilities of the UE that are applicable to both LTE and NR protocols for single connectivity scenarios, and band combination capabilities of the UE that are relevant for dual connectivity scenarios. When the UE has multiple simultaneous connections with network nodes, the frequency bands used for different network nodes must cooperate with each other regardless of the RAT type(s) used. Here, the term “cooperate” means that the UE can operate in the frequency bands without any conflicts or substantial interference—that is, the frequency bands can co-exist. For example, the 3rd Generation Partnership Project (3GPP) Standards specify a set of band combinations that can cooperate with each other. If frequency band 1 and frequency band 2 are not specified as a valid band combination, the UE cannot use frequency band 1 in communication with node 1 and frequency band 2 in communication with node 2 and the same time.

This patent document describes techniques that can be implemented to maintain and improve UE power consumption. With the rapid evolution of cellular mobile communication systems, the UE throughput may increase dramatically. However, the UE battery life may become more important because it is closely related to the user's experience. Using a new radio (NR) system as an example, when a UE is in a RRC IDLE state, the UE may be required to monitor paging occasions and system information. The UE may also be required to measure information on a serving cell and/or intra-frequency neighbor cells as well as inter-frequency neighbor cells for preparing cell re-selection. Similarly, when a UE is in RRC Connected state, with the exception of data transmission and reception, UE may also be required to measure information on multiple frequencies, where the measurement period may be smaller than a period of a UE in RRC Idle state.

Regardless of data transmission or measurements, the UE power consumption may increase. To assist in preserving the UE batter and lower power consumption some systems may include a network that can configure discontinuous Reception (DRX) configuration to a UE. The UE may enter an idle or sleep state when there is no data transmission.

However, from the UE point of view, the UE may be required to wake up to perform measurements, even if the UE is stationary without a quality fluctuation, which results in redundant power consumption. This patent document may provide techniques to reduce the UE power consumption caused by various measurement behaviors.

For dual connectivity UEs, a UE can connect to both a master node (MN) and a secondary node (SN). The MN and SN may or may not belong to the same RAT, and the MN and SN can transmit measurements to the UE, that may increase the UE's battery consumption. This patent document may provide techniques to increase UE power efficiency for dual connectivity UEs.

In some cases, a UE can send UE assistance information to network to inform network whether power saving is needed or not, and network can modify a configuration (e.g. SPS, DRX) to reduce the power consumption.

### Example Embodiment 1

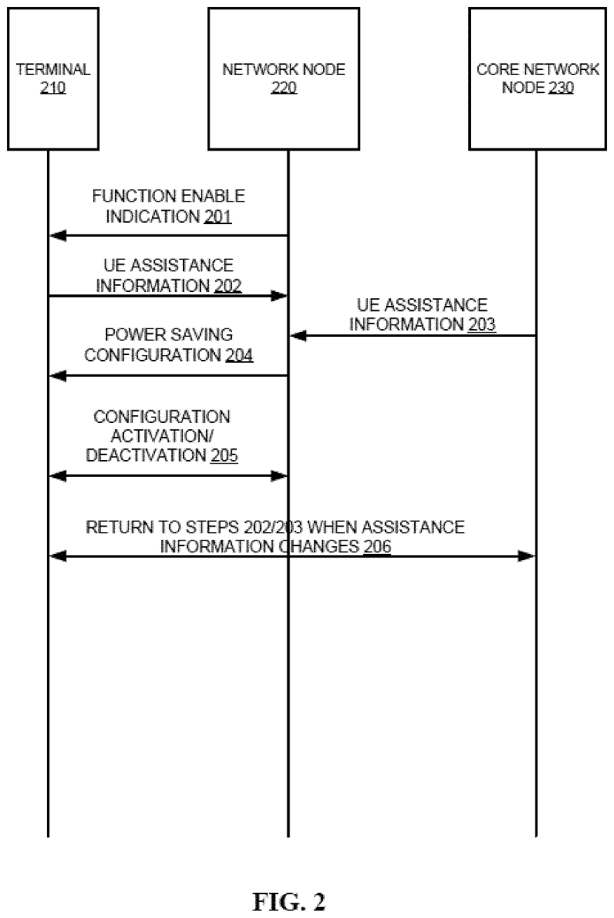

FIG. 2 illustrates a signaling process to manage UE power consumption. In step 201, a network node 220 may transmit a function enable indication to the terminal 210. The function enable indication may indicate to the UE whether the cell enables or disabled a power-saving configuration.

In Step 202, the UE 210 can send terminal assistance information to a network node 220. The terminal assistance information may instruct the network node to configure a power saving configuration.

In step 203, a core network node 230 can send terminal assistance information to a network node. This terminal assistance information may instruct the network node to configure a power saving configuration.

In step 204, the network node 220 may transmit power saving configuration information to the terminal 210.

In step 205, the terminal 210 may activate or deactivate the received configuration based on the received power saving configuration information.

In step 206, if terminal assistance information or the UE power state changes, the UE 210 may go back to steps 202 and/or 203 and send updated terminal assistance information to the network node 220.

Function Enable Indication:

The function enable indication (step 201) may be used to notify a UE as to whether a power saving function is enabled or disabled.

In an embodiment, the power state/configuration may include two states; a power-saving state and a normal state. The function enable indication received by the UE may indicate to the UE whether the power saving function is supported by network. The function indication may also indicate to the UE whether the UE is allowed to switch between the power-saving state and the normal state.

In an embodiment, the power state/configuration may include multiple states; a normal state and multiple power-saving states. Each power-saving state may be associated with specific power-saving functionality. Each state may be associated with a type of UE assistance information reporting. The function enable indication received from the network node may toggle/switch between the multiple states.

The function enable indication may be implicitly expressed by the absence/presence of a threshold parameter or power saving configuration. In other words, a given state/configuration may be associated with a threshold or parameter associated with a configuration or state. The network node may enable/disable a given configuration or power saving state by including or excluding the threshold or parameter associated with that configuration.

From the perspective of a network node, the network node can send the function enable indication via system information and/or UE specific RRC signaling. When the function enable indication is transmitted via system information, it may apply for multiple UEs in a cell. When the function enable indication is transmitted via RRC signaling, it may only be applicable to a specific UE. The function enable indication may be included on a per-cell level, a per-UE level, a per-bandwidth part (BWP) level, or a per-Public Land Mobile Network (PLMN) ID level.

UE Assistance Information

The UE 210 may transmit UE assistance information to the network node 220 (step 202) to facilitate the network node 220 to configure a power saving configuration. The UE assistance information may include at least one of a UE mobility state (e.g. stationary, low speed, medium speed, high speed, etc.) information, an indication that indicates whether a power saving configuration is needed or not, a UE measurement result (e.g. RSRP/RSRQ/SINR of downlink signals, CQI result, etc.), and a UE service characteristic (e.g. small data rate, or traffic pattern). The UE can send above assistance information via one of RRC signaling, MAC layer message, and a physical signal.

In an embodiment, the UE may only send the assistance information when the network indicates that power saving functionality is enabled. In an embodiment, when the content of information is changed, UE can resend the UE assistance information to network.

In an embodiment, the maximum rate at which the assistance information is sent (i.e. how often the UE is allowed to send the assistance information) may be limited and the network may configure an upper limit for this. Such a limit may be associated with the type of assistance information (e.g. different types of assistance information may be allowed to be sent at different rates). For example, there may be some types of UE assistance information which the UE is allowed to at any frequency, while other types of information may be subject to some limits which preclude such information to be sent to often. These limits may be implemented by signaling a prohibit timer to the UE. There may be a specific prohibit timer applicable to each configuration or each type of assistance information from the UE.

In an embodiment, the UE can indicate the capability of whether supporting power saving functionality to network (e.g. via UE radio capability). The UE may only send UE assistance information when the UE capability supports the ability to send the UE assistance information.

As noted in step 203, a core network node 230 may transmit UE assistance information to the network node 220. The network node may configure suitable power saving configuration based on additional UE assistance information sent by the core network node. The UE assistance information may include at least one of a UE mobility behavior (e.g. expected Idle period, mobility frequency, etc.), an indication that indicates whether power saving configuration is needed or not, and a UE service characteristic (e.g. small data rate, or traffic pattern). The core network node may include a mobile management entity (MME) or an authentication management field (AMF). The core network may send the UE assistance information via UE-associated signaling. In an embodiment, when the content of information is changed, core network can resend the UE assistance information to network.

As noted above in step 204, the network node 220 may transmit power adaption configuration information (or a “power saving configuration”) to the terminal 210. A power saving configuration may be associated with a specific UE configuration. The UE configuration may include the overall UE state which is configured the network using system information or RRC signaling. The power saving configuration may include at least one of a measurement configuration, DRX configuration, or another configuration at the UE, which can be configured/reconfigured by the network and influences the overall UE power consumption.

As noted above, a power saving configuration may be associated with the measurement configuration at the UE. The network node can send measurement related power saving configuration based at least one of UE assistance information sent by UE, a network judgment on UE attribution. (e.g. SRS measurement, RSRP/RSRQ measurement results, etc.), and assistance information sent by core network.

In an embodiment, the network node can send power saving configuration to UE via system information or RRC signaling. In an embodiment, the UE can be one of following RRC states: RRC_Idle, RRC_Inactive, RRC_Connected.

In a first configuration, the power saving configuration may include an explicit indication for enabling power saving in RRM measurement. Measurement behavior of the explicit indication may include an increased measurement period (e.g. SMTC measurement period or CSI-RS measurement period), or a reduced measurement sample rate (e.g. SSB sample rate or CSI-RS resource sample rate), for example.

In a second configuration, the power saving configuration may include an SMTC configuration and/or CSI-RS resource configuration for configured measurement object(s). The SMTC configuration may include at least one of a SMTC period, a SMTC window duration, a SSB to measure bitmap.

The CSI-RS resource configuration may include at least one of a CSI-RS resource period, a CSI-RS resource list, a CSI-RS cell list, and a CSI-RS frequency domain location.

In an embodiment, any of the first and second configurations may be implicitly (i.e. by field name) or explicitly (i.e. by explicit indicator) marked for a power saving purpose.

In an embodiment, any of the first and second configurations may be designed to align with UE's DRX configuration, for example, the SSB occasions may be within the DRX ON duration period.

In a third configuration, the power saving configuration may include one or more scaling factors which are used to scale (i.e. increase or decrease) the period of various periodic measurement related events. For example, the above period may include one or more of a SMTC measurement period, a SMTC resource period, a CSI-RS measurement period, and a CSI-RS resource period.

In an embodiment, the scaling factor parameters can be per-UE level configured, per-frequency level configured, per-resource level configured, or intra-freq/inter-freq/inter-RAT level configured.

In an embodiment, the network node can configure an explicit indicator in each measurement object to express whether it should apply a scaling mechanism.

In an embodiment, the UE may apply the configuration by multiplying the period by the scaling factor, or by a pre-defined principle. As an example, the value range of CSI-RS resource period may be {4 ms, 5 ms, 10 ms, 20 ms, 40 ms}. In this example, the network configures CSI-RS resource period=4 ms, and scaling factor=2. Then, the UE applies 10 ms when scaling is activated—i.e. it chooses the valid period that is closest to the period obtained by multiplying the configured value with the scaling factor. As another example, if the network configures CSI-RS resource period=4 ms, and scaling factor is 4, then the UE applies 40 ms when scaling is activated. In this example, the UE chooses the n-th value after the current value.

In a fourth configuration, the power saving configuration may include a bitmap for each beam of serving cell. Each bit in the bitmap which set to “1” may express the requested measured occasions in time domain, when this beam is measured as the best beam for serving cell.

In an embodiment, the bitmap is applicable to SSB resources and/or CSI-RS resources;

In an embodiment, the beam in serving cell can include SSB beams or CSI-RS beams.

In an embodiment, the bitmap can be per-freq level configured.

In an embodiment, the actual beams that the UE measures may be restricted to the beams that are required to be measured in a neighbor cell (as indicated in the SSB to measure a bitmap of the measurement object).

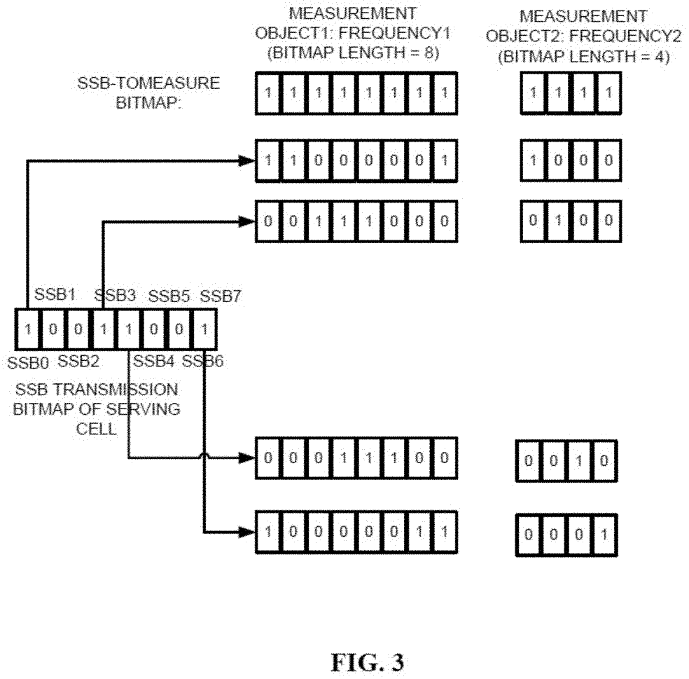

FIG. 3 illustrates an example bitmap for a transmitted beam in a serving cell. For each transmitted beam in serving cell, the network can configure a corresponding bitmap. As shown in FIG. 3, for two measurement objects “frequency1” and “frequency2,” the network node can configure separate bitmaps, where the length of bitmap may be different due to the maximum beam number is different on these frequencies. When the configuration is activated, if the UE measures ssb3 as the best beam of the serving cell, then based on the configured bitmap, UE may only be required to monitor time occasions (e.g., ssb2, ssb3 and ssb4) to detect and measure the neighbor cell SSBs on frequency1, and monitor the time occasions of ssb1 to detect and measure neighbor cell SSBs.

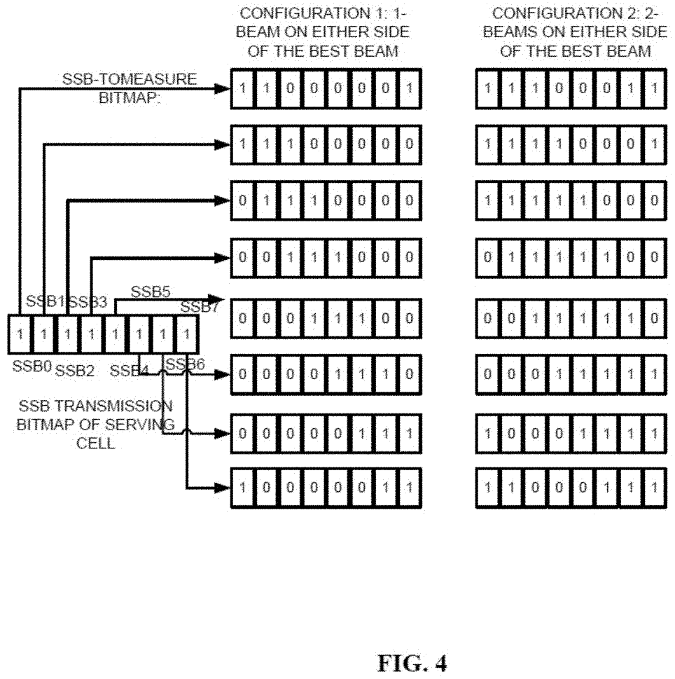

In a fifth configuration, a restricted set of beams measured by the UE may derived by the UE using an implicit rule. For example, the UE may be required to measure a beam that is on either side of the best beam of serving cell. In this example, the UE may have to determine which beams are adjacent (i.e. either side of the best beam). This may be according to a predefined rule. In an example, the SSB IDs that are consecutive are adjacent to each other. The UE may have to measure the SSB with an ID that is one less and one more than the current best SSB as determined by the UE. The number of SSBs that may be measured on either side of the best SSB may be configured by the network. In this scheme, the network may signal a single parameter (which is the number of beams to be monitored on either side of the best beam). FIG. 4 illustrates a bitmap representing beams to be measured.

In a sixth configuration, the power saving configuration may include a value “N” for calculating the measured beam indexes. If the best measured beam index of cell is ‘i’, then UE may only be required to monitor the time occasion of beam index from “i−N” to “i+N” for that cell.

In an embodiment, the cell can be serving cell or neighbor cell.

In an embodiment, the value ‘N’ can be per-frequency configured, or per-cell configured, or per-resource type (SSB or CSI-RS) configured.

In an embodiment, the above beam can include SSB beams or CSI-RS beams.

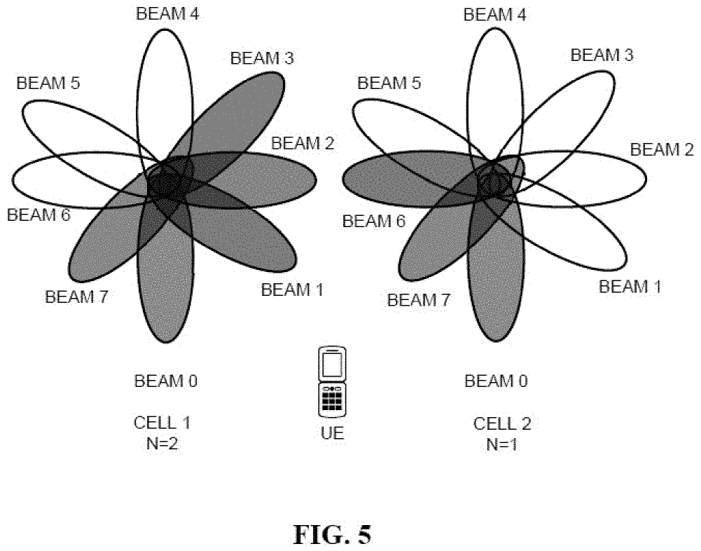

FIG. 5 illustrates a serving cell and a neighbor cell. The network node may configure ‘N=2’ for cell1 and ‘N=1’ for cell2, and UE may detect that Beam1 is the best beam of Cell1, and Beam7 is the best beam of Cell2. When the power saving configuration is activated, then UE may only be required to monitor the time occasions of “Beam0/1/2/3/7” of Cell1, and the time occasions of “Beam0/6/7” of Cell2 and perform measurement on the beam(s) if detected.

In a seventh configuration, for the cells listed in a measurement object which may be measured by UE, the network node can configure a corresponding bitmap for each beam of serving cell. Each bit in the bitmap may correspond to one entry in the cell list. The UE may detect the best beam of serving cell, and UE may only be required to measure on the cells which corresponding bit is set to ‘1’ in the relevant bitmap.

In an embodiment, the above cell list can be the cell list in measurement object for SSB based measurement, and/or the cell list in measurement objective for CSI-RS based measurement.

In an embodiment, the above beam in serving cell can be SSB beams or CSI-RS beams.

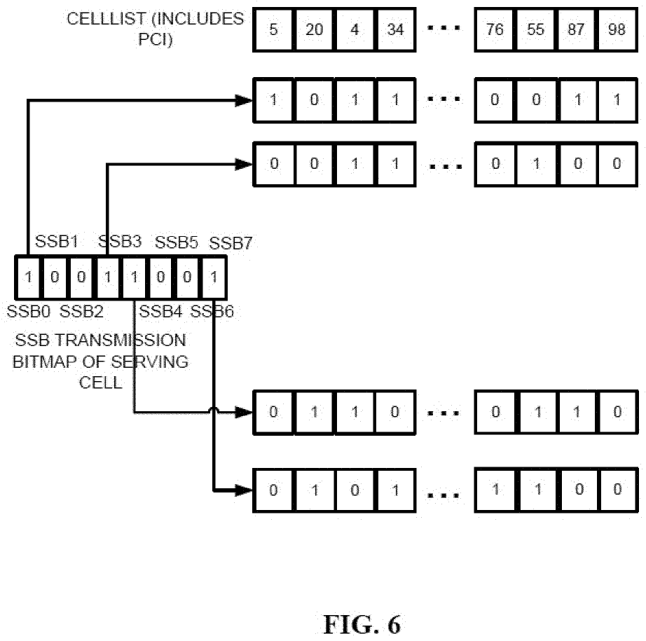

FIG. 6 is an illustration of a bitmap for a measured cell list. The network may configure a measured cell list for a given frequency (measurement object), where the cell list may include multiple PCIs: 5, 20, 4 . . . 55, 87, 98. For each transmitted SSB of serving cell, the network node may configure a corresponding bitmap, when the power saving configuration is activated. If the UE measures ssb3 is the best beam of serving cell, then based on the configured bitmap, UE may only be required to monitor and detect neighbor cell PCI=4, . . . , and PCI=55, and perform measurement on these cells once detected.

As noted in step 205 of FIG. 2, a terminal may activate a power saving configuration. In an embodiment, the relationship between a power saving configuration and an activation method can be pre-defined or based on an explicit indication.

In a first embodiment, a UE activates the received power saving configuration directly upon reception of the configuration from network.

In a second embodiment, the UE may activate the received power saving configuration by receiving an explicit network indication.

In an embodiment, indication information can be transmitted via system information, RRC dedicated signaling, MAC signaling, a MAC message, or a physical signal.

In an embodiment, the indication information can be or per-frequency level configured, per-cell level configured, or per-UE level configured, or per-bwp level configured, or per-PLMN level configured.

In a third embodiment, the UE may activate the received power saving configuration based on UE's additional estimation. For example, UE may determine whether the quality of serving cell fulfills (i.e. exceeds in case of RSRP/RSRQ/SINR, or falls below in case of doppler shift) a threshold. In an embodiment, the above serving cell can be PCell, or SCell. In an embodiment, the threshold can include at least one of a RSRP value, a RSRQ value, a SINR value, and a Doppler shift value. The threshold can be pre-defined, or explicitly configured by network. The threshold can be per-frequency level configured, per-cell level configured, or per-UE level configured, or per-BWP level configured, or per-PLMN level configured. For different power saving configurations, different thresholds can be used.

As an example, a network node may configure two power saving configurations to UE, where one is an independent SMTC configuration with an activation threshold (e.g. RSRP=−80 dBm), and the other power saving configuration has a scaling factor with a SMTC period together with an activation threshold (e.g. SINR=−5 dB). In this example, the UE may perform measurement of PCell. If the RSRP of PCell is above −80 dBm, the UE may carry out the power saving configuration of independent SMTC configuration. When the SINR of PCell is above −5 dB, the UE may carry out the power saving configuration of scaling factor to the SMTC period.

In a fourth embodiment, the UE may activate the received power saving configuration based on a Timer. The timer may start upon reception of the power saving configuration from network, and UE may activate the power saving configuration when the timer expires. The length of timer can be pre-defined, or explicitly configured by network. The timer can be per-frequency level configured, per-cell level configured, or per-UE level configured, or per-BWP level configured, or per-PLMN level configured. For different power saving configurations, a timer with various durations may be used.

As noted in step 205 of FIG. 2, a terminal may deactivate a power saving configuration. The relationship between power saving configuration and deactivation method can be pre-defined or based on explicit indication.

In a first embodiment, the UE may deactivate the power saving configuration when the configuration is released or modified by network.

In a second embodiment, the UE may deactivate the received power saving configuration by receiving an explicit network indication. Indication information can be transmitted via system information or RRC dedicated signaling, MAC signaling, MAC message, or a physical signal. The indication information can be per-frequency level configured, per-cell level configured, or per-UE level configured, or per-bwp level configured, or per-PLMN level configured.

In a third embodiment, the UE may deactivate the received power saving configuration based on a UE additional estimation. For example, the UE may determine whether the quality of serving cell falls below a threshold (or exceeds a threshold in case of doppler shift), or whether the quality of serving cell falls below the previous activation threshold. The serving cell can be PCell, or SCell. The threshold can be one of RSRP, RSRQ, SINR or Doppler shift threshold. The threshold can be pre-defined, or explicitly configured by network. The threshold can be per-frequency level configured, per-cell level configured, or per-UE level configured, or per-BWP level configured, or per-PLMN level configured. For different power saving configurations, different thresholds can be used.

In a fourth embodiment, the UE may deactivate the received power saving configuration based on a timer. The timer may start upon reception of the power saving configuration from network or upon activation of the power saving configuration, and the UE may deactivate the power saving configuration when the timer expires. The length of timer can be pre-defined, or explicitly configured by network. The timer can be per-frequency level configured, per-cell level configured, or per-UE level configured, or per-BWP level configured, or per-PLMN level configured. For different power saving configurations, different length of timer can be used.

For a UE configured with dual connectivity, the UE may be connected to multiple nodes, a primary node (MN) and secondary node (SN). The MN and SN can belong to the same RAT (e.g. NR-DC), or they can belong to different RAT (e.g. EN-DC, NGEN-DC or NE-DC).

A Function enable indication for dual connectivity, the MN only may indicate to the UE whether a power saving function is enabled or disabled.

For UE assistance information with a DC UE, a first embodiment may include the UE sending the UE assistance information to the MN. The MN may forward the assistance information to SN, or MN can indicate SN that power saving configuration is needed.

A second embodiment may include the UE sending the UE assistance information to both the MN and SN. The UE can send the assistance information to MN and SN independently, for example, if the measurements associated with a measurement object configured by MN is power consuming, then UE can send the assistance information to MN to ask for power saving configuration. If the measurements configured by SN is power consuming, the UE can send the assistance information to SN to request power saving configuration.

For UE assistance information from a core network node, a core network node may send the UE assistance information to a MN. The MN can forward the assistance information to SN, or MN can indicate SN that power saving configuration is needed.

For the power saving configuration activation, a MN can configure power saving configuration to UE, and is applicable to one or more of the measurement configurations configured by both MN and SN. The MN can inform SN that power saving function is enabled. The MN can forward one or more of measurement configurations to SN. The SN can request MN to enable power saving function, and request MN to send power saving configuration to UE. In this case, MN may make the final decision and informs SN.

In a second embodiment, both MN and SN can configure power saving configuration to UE. The configuration may be by MN is applicable to one or more of the measurements configured by MN, and the configuration sent by SN may be applicable to one or more of the measurements configured by SN. The MN and SN can decide whether to send power saving configuration to UE separately. The power saving configuration may be sent by SN and can be delivered directly from SN to UE (e.g. via SRB3), or through MN to UE (e.g. via SRB1).

For a power saving configuration deactivation, a first embodiment may include a MN sending a deactivation indication to the UE. The MN can forward the deactivation indication to SN or informs SN that one or more of power saving configurations are deactivated. The indication may be sent by MN can be used to deactivate one or more of the power saving configurations configured by both MN and SN.

In a second embodiment, both the MN and SN can send deactivation indication to UE. The indication may be sent by MN and may be used to deactivate the power saving configuration configured by MN, and the indication sent by SN is used to deactivate the power saving configuration sent by SN.

In a third embodiment, the UE may decide whether to deactivate the configured power saving configuration based on the estimation of quality of serving cell in MN. The serving cell in MN can be PCell, or SCell in MN. When the UE determines that the quality of serving cell in MN fulfills the threshold, the UE can activate one or more of the power saving configuration configured by both MN and SN.

In a fourth embodiment, the UE may decide whether to activate the configured power saving configuration based on the estimation of quality of serving cell in MN and quality of serving cell in SN separately. The serving cell in MN can be PCell, or SCell in MN. The serving cell in SN can be PSCell or SCell in SN. When the UE determines that the quality of serving cell in MN fulfills the threshold, the UE can activate one or more of the power saving configuration configured by MN. When the UE determines the quality of serving cell in SN fulfills the threshold, the UE can activate one or more of the power saving configuration configured by SN.

For a power saving configuration activation, a first embodiment may include the MN sending activation information to the UE. The MN can forward the activation indication to SN or inform SN that one or more of power saving configurations are activated. The indication sent by MN can be used to activate one or more of the power saving configurations configured by both MN and SN.

In a second embodiment, both MN and SN can send activation indication to UE. The indication sent by MN may be used to activate the power saving configuration configured by MN, and the indication sent by SN is used to activate the power saving configuration sent by SN.

In a third embodiment, the UE may decide whether to activate the configured power saving configuration based on the estimation of quality of serving cell in MN. The serving cell in MN can be PCell, or SCell in MN. When the UE determines that the quality of serving cell in MN fulfills the threshold, the UE can activate one or more of the power saving configuration configured by both MN and SN.

In a fourth embodiment, the UE may decide whether to activate the configured power saving configuration based on the estimation of quality of serving cell in MN and quality of serving cell in SN separately. The serving cell in MN can be PCell, or SCell in MN. The serving cell in SN can be PSCell or SCell in SN. If the UE determines that the quality of serving cell in MN fulfills a threshold, or no longer fulfill the previous activation threshold, the UE can deactivate one or more of the power saving configuration configured by MN. If the UE determines the quality of serving cell in SN fulfills a threshold, or no longer fulfill the previous activation threshold, the UE can deactivate one or more of the power saving configuration configured by SN.

The UE can be configured with power saving configurations, and these configurations may be carried out through at least one of: directly upon reception, activated/de-activated by network indication, and activated/de-activated by UE based on additional estimation. The network activated/de-activated indication can be transmitted via RRC dedicated signaling or MAC signal or MAC message or physical signal. A core network can send assistance information to network to facilitate network to configure/re-configure the power saving configurations. The UE can send assistance information to network to facilitate network to configure/re-configure the power saving configurations.

The UE assistance information may include one or more of: UE mobility states indication (e.g. low, stationary), UE power state indication to represent whether power saving is needed or not, and a UE service characteristic.

The UE assistance information may be carried in RRC signaling, or by MAC indication, or by new physical signal. The UE can send assistance information can based on the indication information from network.

The indication information includes one or more of the following: a single switch, multiple switches associated with different assistance information reporting, and the presence/absence of threshold or power saving configuration.

The indication information can be per-frequency level configured, per-cell level configured, or per-UE level configured, or per-BWP level configured, or per-PLMN level configured. The indication information can be transmitted via system information or RRC dedicated signaling.

The power saving configurations can be configured by network or based on pre-defined configurations. For network configuration, the power saving configurations can be transmitted via system information or RRC dedicated signaling. The power saving configuration may include one or more of: an explicit indication for enabling power saving in measurement, an additional SMTC configuration (i.e. including SMTC periodicity or SMTC window duration), and a CSI-RS resource configuration (i.e. CSI-RS periodicity, CSI-RS resource list, CSI-RS freq domain position).

One or more of the SMTC configurations may be designed to align with the UE's DRX ON duration for a specific UE. Additional SMTC period or CSI-RS resource period; and it may be applicable to all measured frequencies, or it may be applicable to the frequency which together with an explicit indication set to TRUE. Scale factor to SMTC period or CSI-RS resource periodicity, which may be applicable to all measured frequencies, or may be applicable to the frequency which together with an explicit indication set to TRUE.

Several bitmaps for each beam of serving cell. The bitmap may be set to “1” express the measured occasions in time domain when this beam is measured as the best beam for serving cell.

Value N for candidate measured beams, e.g. for serving cells or neighbor cells, if the beat measured beam index of one cell is T, then UE may only measure the beam occasions for beam index from “i−N” to “i+N” for that cell.

Several bitmaps for each beam of serving cell. Each bit in the bitmap may correspond to the same entry in whiteCellList, then UE may measure that indicated neighbor cell if the bit is set to “1.”

A network node can configure one or more RSRP/RSRQ/SINR/doppler shift thresholds together with above power saving configurations, and UE may activate and deactivate the power saving configuration by comparing the threshold and the quality of serving cell.

The network node can configure one or more timers together with above power saving configurations, and UE may activate and deactivate the power saving configuration based on the expiry of timers.

The power saving configuration may implicitly (i.e. by field name) or explicitly (i.e. by addition indication) be marked as “for power saving purpose.”

For MR-DC UEs, MN can configure power saving configuration to UE, and MN can forward the power saving configuration to SN, or MN can send an explicitly notification to SN via inter-node message about the enabling of power saving;

For MR-DC UEs, both MN and SN can configure power saving configurations to UE independently;

For MR-DC UEs, SN can send power saving request to MN via inter-node message.

For MR-DC UEs, UE can send assistance information to MN, and MN can forward it to SN; or UE can send separate assistance information to MN and SN.

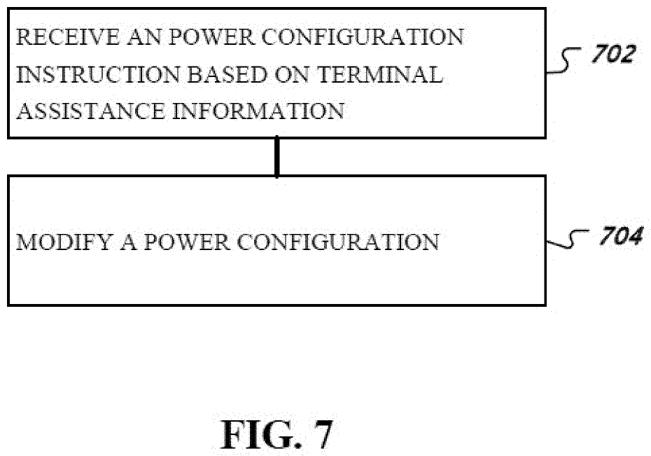

FIG. 7 illustrates a block diagram of a method for improving terminal power consumption. A terminal may receive a power configuration instruction based on terminal assistance information from a network node (block 702). The terminal may modify a power configuration based on the power configuration instruction (block 704).

In some embodiments, the method includes receiving, by the terminal, a function indication from the network node; and transmitting, by the terminal, terminal assistance information to the network node based on the function indication.

In some embodiments, modifying the power configuration includes activating a power saving mode at the terminal.

In some embodiments, modifying the power configuration includes deactivating a power saving mode at the terminal.

In some embodiments, the power saving mode is associated with a terminal state.

In some embodiments, the terminal state is based on one of a measurement configuration of the terminal and a discontinuous reception (DRX) configuration of the terminal.

In some embodiments, the power configuration instruction is transmitted by the network node based on at least one of a terminal assistance information transmitted by the terminal, a sounding reference signal (SRS) measurement, a RSRP measurement, a RSRQ measurement, and a terminal assistance information transmitted by the core network node. In some embodiments, the power configuration instruction is configured on one of a per-frequency level, a per-terminal level, a per-cell group level, a per-BWP level, and a per-public land mobile network (PLMN) level.

In some embodiments, the function indication is configured on one of a per-frequency level, a per-terminal level, a per-BWP level, a per-cell group level, and a per-public land mobile network (PLMN) level.

In some embodiments, the power configuration instruction indicates an increase to a measurement period of the terminal or a reduction of a measurement sample rate of the terminal.

In some embodiments, the power configuration instruction includes a synchronization signal block (SSB) based RRM measurement timing configuration (SMTC) that includes at least one of a STMC period, a SMTC duration, and a SSB to measure bitmap.

In some embodiments, the power configuration instruction includes a channel state information reference signal (CSI-RS) resource configuration that includes at least one of a CSI-RS resource period, a CSI-RS resource list, a cell list, and a CSI-RS frequency domain location.

In some embodiments, the power configuration instruction includes a scaling value to scale a measurement period of the terminal.

In some embodiments, the measurement period includes at least one of a SMTC measurement period, a SMTC resource period, a CSI-RS measurement period, and a CSI-RS resource period.

In some embodiments, the power configuration instruction includes a bitmap for a beam of a serving cell.

In some embodiments, the bitmap is associated with SSB resources or CSI-RS resources.

In some embodiments, the beam of the serving cell is one of a SSB beam or a CSI-RS beam.

In some embodiments, the method includes measuring, by the terminal, each of a plurality of beams that are associated with a neighboring cell based on the bitmap.

In some embodiments, the terminal measures each of a plurality of beams that are adjacent to the beam of the serving cell.

In some embodiments, the power configuration instruction includes a plurality of bitmaps corresponding to each beam of a serving cell.

In some embodiments, the method includes measuring, by the terminal, each cell indicated by the plurality of bitmaps.

In some embodiments, the method includes receiving, by the terminal, an indication message from the network node instructing the terminal to activate the power saving mode, wherein the power saving mode is activated based on receiving the indication message.

In some embodiments, the indication message is transmitted to the terminal by one of a system information, an RRC dedicated signaling, a MAC signaling, and a physical signal.

In some embodiments, the method includes measuring, by the terminal, a quality value of a serving cell, wherein the power saving mode is activated based on the quality value of the serving cell exceeding a threshold.

In some embodiments, the threshold includes one of a RSRP value, a RSRQ value, a SINR value, and a doppler shift value.

In some embodiments, the power saving mode is activated based on an activate timer expiring.

In some embodiments, the activate timer is started upon receiving the power configuration instruction from the network node.

In some embodiments, the method includes receiving, by the terminal, an indication that the network node has released the power configuration, wherein the power saving mode is deactivated based on the indication that the network node has released the power configuration.

In some embodiments, the indication that the network node has released the power configuration is transmitted via one of a system information, an RRC dedicated signaling, a MAC signaling, and a physical signal.

In some embodiments, the method includes measuring, by the terminal, a quality value of a serving cell, wherein the power saving mode is deactivated based on the quality value of the serving cell no longer exceeds a deactivate threshold.

In some embodiments, the deactivate threshold includes one of a RSRP value, a RSRQ value, a SINR value, and a doppler shift value.

In some embodiments, the power saving mode is deactivated based on a deactivate timer expiring.

In some embodiments, the deactivate timer is started upon receiving the power configuration instruction from the network node or enabling the power saving mode.

In some embodiments, the method includes transmitting, by the terminal, the terminal assistance information to the network node.

In some embodiments, the network node receives the terminal assistance information from a core network node.

In some embodiments, the method includes transmitting, by the terminal, updated terminal assistance information to the network node based the power saving mode being activated.

In some embodiments, the power configuration is modified between a normal configuration and multiple power-saving configurations, wherein each configuration is associated with a specific power-saving function.

In some embodiments, the function indication is transmitted by one of a radio resource control (RRC) signal and a system information message.

In some embodiments, the terminal assistance information includes at least one of a terminal mobility state information, an indication that the terminal requests the power configuration instruction, an indication that the terminal does not request the power configuration instruction, a terminal measurement information, and a terminal service characteristic.

In some embodiments, the terminal measurement information includes at least one of a reference signal received power (RSRP), a reference signal received quality (RSRQ), a signal to interference noise ratio (SINR), and a channel quality indicator (CQI) result.

In some embodiments, the terminal assistance information is transmitted by one of an RRC message, a medium access control (MAC) layer message, and a physical signal.

In some embodiments, the terminal assistance information is transmitted by the terminal based on receiving the function indication instructing the terminal to enabling a power saving mode at the terminal.

In some embodiments, the terminal assistance information is transmitted based on an expiration of a prohibit timer.

In some embodiments, the terminal assistance information includes at least one of terminal mobility behavior information, an indication that the terminal requests the power configuration information, and an indication that the terminal does not request the power configuration information.

In some embodiments, the terminal assistance information is transmitted via a terminal-specific signaling.

In another exemplary embodiment, a method for wireless communication includes transmitting, by a network node, a power configuration instruction based on terminal assistance information to a terminal, wherein the terminal is configured to modify a power configuration based on the power configuration instruction. The method also includes receiving, by the network node, updated terminal assistance information from the terminal.

In some embodiments, the method includes transmitting, by the network node, a function indication to the terminal, wherein the terminal is configured to modify the power configuration based on the function indication.

In some embodiments, modifying the power configuration includes enabling a power saving mode at the terminal.

In some embodiments, the method includes receiving, by the network node, terminal assistance information from a core network node.

In some embodiments, the terminal assistance information includes at least one of a terminal mobility state information, an indication that the terminal requests the power configuration instruction, an indication that the terminal does not request the power configuration instruction, a terminal measurement information, and a terminal service characteristic.

In some embodiments, the power configuration instruction is transmitted by the network node based on at least one of the updated terminal assistance information transmitted by the terminal, a sounding reference signal (SRS) measurement, reference signal received power (RSRP), a reference signal received quality (RSRQ), and the terminal assistance information transmitted by the core network node.

In some embodiments, the method includes transmitting, by the network node, an indication message to the terminal to enable a power saving mode at the terminal.

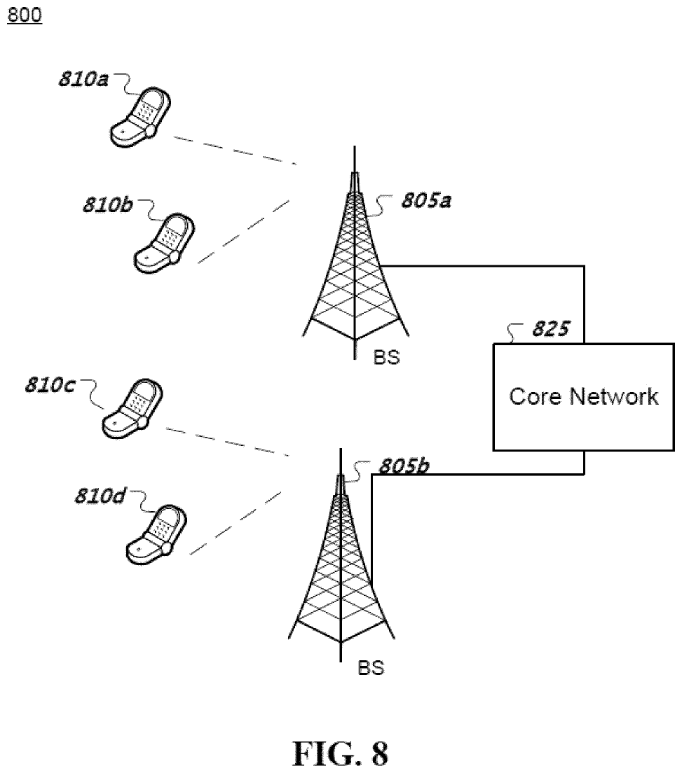

FIG. 8 shows an example of a wireless communication system where techniques in accordance with one or more embodiments of the present technology can be applied. A wireless communication system 800 can include one or more base stations (BSs) 805a, 805b, one or more wireless devices 810a, 810b, 810c, 810d, and a core network 825. A base station 805a, 805b can provide wireless service to wireless devices 810a, 810b, 810c and 810d in one or more wireless sectors. In some implementations, a base station 805a, 805b includes directional antennas to produce two or more directional beams to provide wireless coverage in different sectors.

The core network 825 can communicate with one or more base stations 805a, 805b. The core network 825 provides connectivity with other wireless communication systems and wired communication systems. The core network may include one or more service subscription databases to store information related to the subscribed wireless devices 810a, 810b, 810c, and 810d. A first base station 805a can provide wireless service based on a first radio access technology, whereas a second base station 805b can provide wireless service based on a second radio access technology. The base stations 805a and 805b may be co-located or may be separately installed in the field according to the deployment scenario. The wireless devices 810a, 810b, 810c, and 810d can support multiple different radio access technologies.

In some implementations, a wireless communication system can include multiple networks using different wireless technologies. A dual-mode or multi-mode wireless device includes two or more wireless technologies that could be used to connect to different wireless networks.

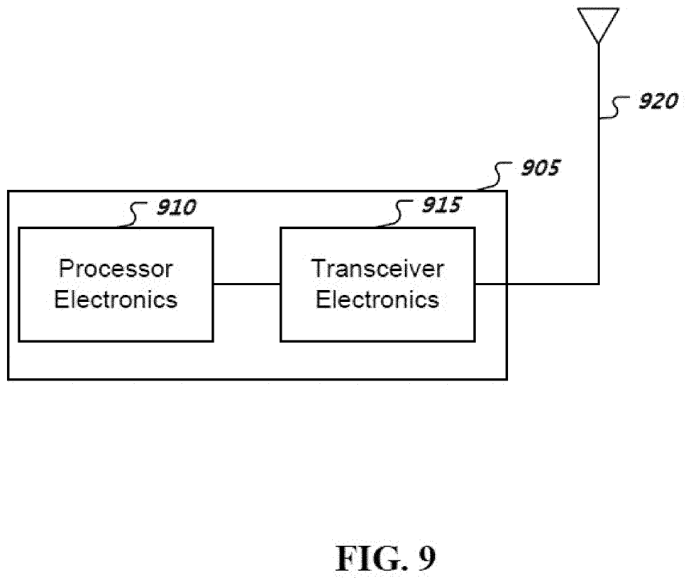

FIG. 9 is a block diagram representation of a portion of a hardware platform. A hardware platform 905 such as a network device or a base station or a wireless device (or UE) can include processor electronics 910 such as a microprocessor that implements one or more of the techniques presented in this document. The hardware platform 905 can include transceiver electronics 915 to send and/or receive wired or wireless signals over one or more communication interfaces such as antenna 920 or a wireline interface. The hardware platform 905 can implement other communication interfaces with defined protocols for transmitting and receiving data. The hardware platform 905 can include one or more memories (not explicitly shown) configured to store information such as data and/or instructions. In some implementations, the processor electronics 910 can include at least a portion of the transceiver electronics 915. In some embodiments, at least some of the disclosed techniques, modules or functions are implemented using the hardware platform 905.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1-53. (canceled)

54. A method for wireless communication, comprising:
receiving, by a terminal, a power configuration instruction from a network node, wherein the power configuration instruction is based on terminal assistance information; and
modifying, by the terminal, a power configuration based on the power configuration instruction.

55. The method of claim 54, further comprising:
receiving, by the terminal, a function indication from the network node; and
transmitting, by the terminal, the terminal assistance information to the network node based on the function indication.

56. The method of claim 54, wherein modifying the power configuration comprises activating a power saving mode at the terminal, and wherein the power saving mode is associated with a terminal measurement behavior, wherein the terminal measurement behavior comprises at least one of an increased measurement period or a reduced measurement sample rate.

57. The method of claim 54, wherein modifying the power configuration comprises activating a power saving mode at the terminal, and wherein the power saving mode is associated with a terminal configuration, wherein the terminal configuration comprises at least one of a measurement configuration of the terminal, a discontinuous reception (DRX) configuration of the terminal, and another configuration that influences power consumption of the terminal.

58. The method of claim 54, further comprising:
receiving, by the terminal, an indication message from the network node instructing the terminal to activate the power saving mode, wherein the power saving mode is activated based on receiving the indication message.

59. The method of claim 54, further comprising:
receiving, by the terminal, an indication message from the network node instructing the terminal to deactivate the power saving mode, wherein the power saving mode is deactivated based on receiving the indication message.

60. The method of claim 54, further comprising:
measuring, by the terminal, a quality value of a serving cell, wherein the power saving mode is activated based on the quality value of the serving cell fulfilling a threshold, and wherein the threshold comprises at least one of a RSRP value, a RSRQ value, a SINK value, and a doppler shift value.

61. The method of claim 54, wherein the power configuration instruction is configured on one of a per-frequency level, a per-terminal level, a per-cell group level, a per-BWP level, and a per-public land mobile network (PLMN) level.

62. The method of claim 54, wherein the power configuration instruction comprises a scaling value to scale a measurement period of the terminal.

63. The method of claim 54, wherein the terminal assistance information comprises at least one of a terminal mobility state information, an indication that the terminal requests the power configuration instruction, an indication that the terminal does not request the power configuration instruction, a terminal measurement information, and a terminal service characteristic.

64. A method for wireless communication, comprising:
receiving, by a network node, a terminal assistance information from a terminal; and
transmitting, by the network node to the terminal, a power configuration instruction based on the terminal assistance information, wherein the terminal is configured to modify a power configuration based on the power configuration instruction.

65. The method of claim 64, further comprising:
transmitting, by the network node, a function indication to the terminal to enable the terminal to transmit terminal assistance information to the network node.

66. The method of claim 64, wherein modifying the power configuration comprises one of activating a power saving mode at the terminal or deactivating a power saving mode at the terminal.

67. The method of claim 64, wherein the terminal assistance information comprises at least one of a terminal mobility state information, an indication that the terminal requests the power configuration instruction, an indication that the terminal does not request the power configuration instruction, a terminal measurement information, and a terminal service characteristic.

68. A terminal for wireless communication, comprising a memory for storing instructions and a processor in communication with the memory, wherein the processor is configured to execute the instructions to cause the terminal to:
receive a power configuration instruction from a network node, wherein the power configuration instruction is based on terminal assistance information; and
modify a power configuration based on the power configuration instruction.

69. The terminal of claim 68, wherein, when the processor executes the instructions, the processor is configured to further cause the terminal to:
receive a function indication from the network node; and
transmit the terminal assistance information to the network node based on the function indication.

70. The terminal of claim 68, wherein:
when the processor is configured to cause the terminal to modify the power configuration based on the power configuration instruction, the processor is configured to cause the terminal to activate a power saving mode at the terminal; and
the power saving mode is associated with a terminal configuration, wherein the terminal configuration comprises at least one of a measurement configuration of the terminal, a discontinuous reception (DRX) configuration of the terminal, and another configuration that influences power consumption of the terminal; or
the power saving mode is associated with a terminal measurement behavior, wherein the terminal measurement behavior comprises at least one of an increased measurement period or a reduced measurement sample rate.

71. The terminal of claim 70, wherein, when the processor executes the instructions, the processor is configured to further cause the terminal to:
receive an indication message from the network node instructing the terminal to activate the power saving mode, wherein the power saving mode is activated based on receiving the indication message.

72. The terminal of claim 71, wherein, when the processor executes the instructions, the processor is configured to further cause the terminal to:
measure a quality value of a serving cell, wherein the power saving mode is activated based on the quality value of the serving cell fulfilling a threshold, and wherein the threshold comprises at least one of a RSRP value, a RSRQ value, a SINK value, and a doppler shift value.

73. The terminal of claim 68, wherein the power configuration instruction is transmitted by the network node based on at least one of a terminal assistance information transmitted by the terminal, a sounding reference signal (SRS) measurement, a RSRP measurement, a RSRQ measurement, and a terminal assistance information transmitted by a core network node.
